(19) United States
(12) Patent Application Publication
(10) Pub. No.: US 2008/0074702 A1
(43) Pub. Date: Mar. 27, 2008

(54) Image information output apparatus, image information output method, recording medium, computer data signal, and image information output system

(75) Inventor: Nobukazu Miyoshi, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 11/725,438

(22) Filed: Mar. 20, 2007

(30) Foreign Application Priority Data
Sep. 26, 2006 (JP) 2006-260654

(51) Int. Cl. H04N 1/40; G06K 9/00; G06K 15/00

(52) U.S. Cl. 358/3.28; 382/100

(57) ABSTRACT

An image information output apparatus includes: an image processing section that performs image processing on image information; an image information output section that outputs the image information subjected to image processing by the image processing section; a falsification detecting section that detects that the image information has been falsified in a process in which the inputted image information is subjected to image processing by the image processing section and is outputted by the image information output section; and a control section that controls an output of the image information by the image information output section based on a detection result detected by the falsification detecting section.

### CROSS-REFERENCE TO RELATED APPLICATIONS

This application is based on and claims priority under 35 USC 119 from Japanese Patent Application No. 2006-260654 filed Sep. 26, 2006.

### BACKGROUND

(i) Technical Field

The present invention relates to an image information output apparatus, an image information output method, a recording medium storing a program for outputting an image information, a computer data signal, and an image information output system.

(ii) Related Art

In a copying apparatus, a technique is known in which if an attempt is made to copy the contents whose counterfeiting by reproduction is prohibited, the prohibition of counterfeiting is detected by image analysis, and a predetermined pattern image is printed.

### SUMMARY

In accordance with an aspect of the invention there is provided an image information output apparatus including: an image processing section that performs image processing on image information; an image information output section that outputs the image information subjected to image processing by the image processing section; a falsification detecting section that detects that the image information has been falsified in a process in which the inputted image information is subjected to image processing by the image processing section and is outputted by the image information output section; and a control section that controls an output of the image information by the image information output section based on a detection result detected by the falsification detecting section.

### BRIEF DESCRIPTION OF THE DRAWINGS

Exemplary embodiments of the present invention will be described in detail based on the following figures, wherein:

FIG. 1 is a block diagram illustrating an example of an information processor which makes use of the invention;

FIG. 2 is a block diagram in which attention is focused on one form of operation of the information processor illustrated in FIG. 1;

FIG. 3 is a flowchart illustrating an example of the operation which is executed by the information processor illustrated in FIG. 1;

FIGS. 4A to 4C are conceptual diagrams illustrating the states of output of print paper or states of printing on the print paper on the basis of a timing at which data falsification is detected;

FIG. 5 is a flowchart illustrating another example of the operation which is executed by the information processor illustrated in FIG. 1;

FIG. 6 is a block diagram in which attention is focused on another form of operation of the information processor illustrated in FIG. 1;

FIG. 7 is a block diagram in which attention is focused on still another form of operation of the information processor illustrated in FIG. 1;

FIGS. 8A and 8B are flowcharts illustrating still other examples of the operation which is executed by the information processor illustrated in FIG. 1; and

FIG. 9 is a conceptual diagram illustrating an example of an information processing system which makes use of the invention.

### DETAILED DESCRIPTION

### 1. First Exemplary Embodiment (Configuration of the Exemplary Embodiment)

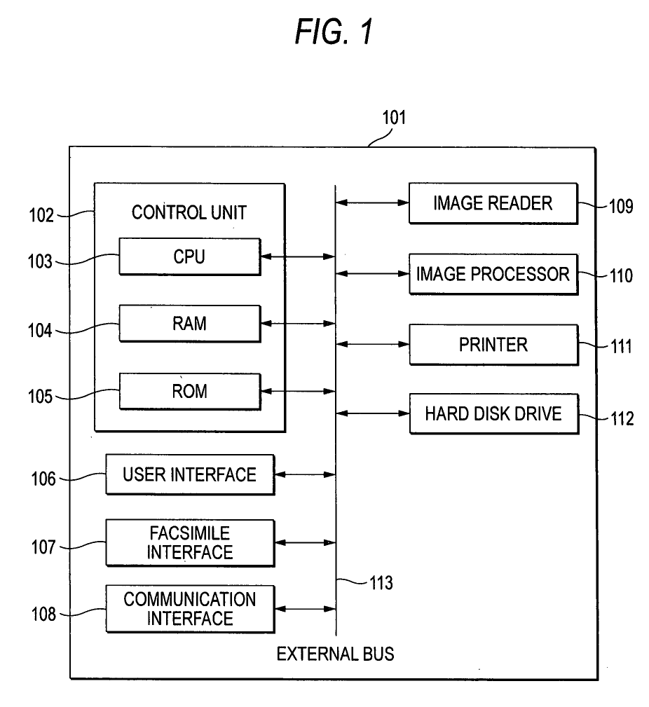

Hereafter, a description will be given of an example in which the invention is used. FIG. 1 is a block diagram illustrating one example of an information processor which makes use of the invention. An information processor 101 shown in FIG. 1 has three functions of a copying machine, a facsimile transceiver, and a printer. The printer referred to herein means a device which performs printing on the basis of print data transmitted from a terminal of a personal computer or the like as well as printing based on print data recorded on an appropriate storage medium.

The information processor 101 is comprised of a control unit 102 connected to an external bus 113; a user interface 106; a facsimile interface 107; a communication interface 108; an image reader 109; an image processor 110; a printer 111; and a hard disk drive 112.

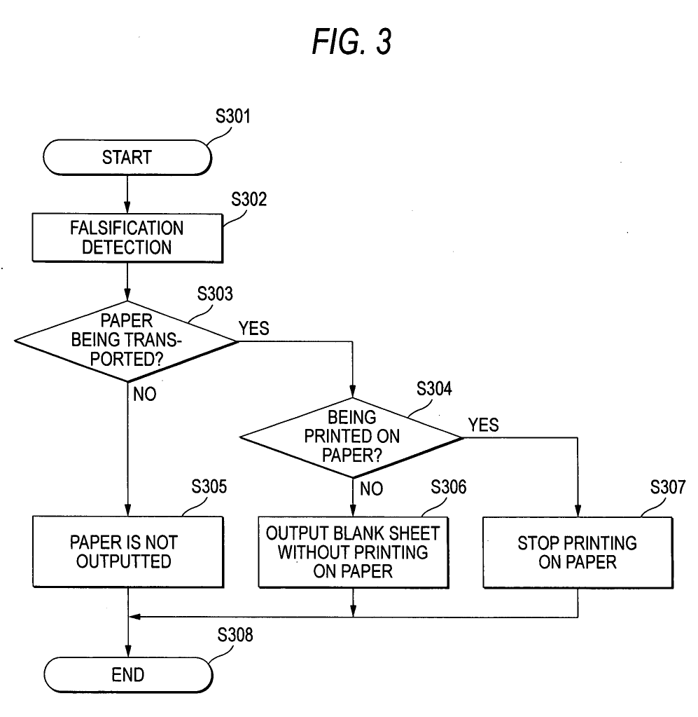

The control unit 102 controls the operation of the information processor 101 and executes processings shown in FIGS. 3, 5, and 8 which will be referred to later. For example, the control unit 102 monitors the state of transport of print paper in the printer 111 and the state of progress of printing, and controls the transport of the print paper and the printing operation on the basis of the details of these monitorings.

The control unit 102 has a central processing unit (CPU) 103, a random access memory (RAM) 104, and a read only memory (ROM) 105. Various operation programs, setting parameters, and the like are stored in the ROM 105. Included among these operation programs are various operation programs for controlling the operation of the information processor 101 and operation programs for executing processings shown in FIGS. 3, 5, and 8 which will be referred to later. The CPU 103 executes processing in accordance with the operation programs stored in the ROM 105.

The RAM 104 is used as a working area for temporarily storing programs stored in the ROM at the time of the execution of the programs and temporarily storing necessary data at the time of various processing by the CPU 103. In addition, the RAM 104 has a nonvolatile memory area and stores various data necessary for the operation of the information processor 101 (e.g., data on the remaining amount of toner).

The user interface 106 has an image display device (e.g., a liquid-crystal display device) for informing a user (the user of the information processor 101) of various information as well as an input device (e.g., a keyboard input device) for providing various settings and operation with respect to the information processor 101. The facsimile interface 107 has the function of transmitting and receiving facsimile data by using a telephone line. The communication interface 108 has the function of performing communication using an appropriate communication line, e.g., a local area network (LAN) or the Internet. For instance, the information processor 101 is connected to a LAN by using the communication interface 108.

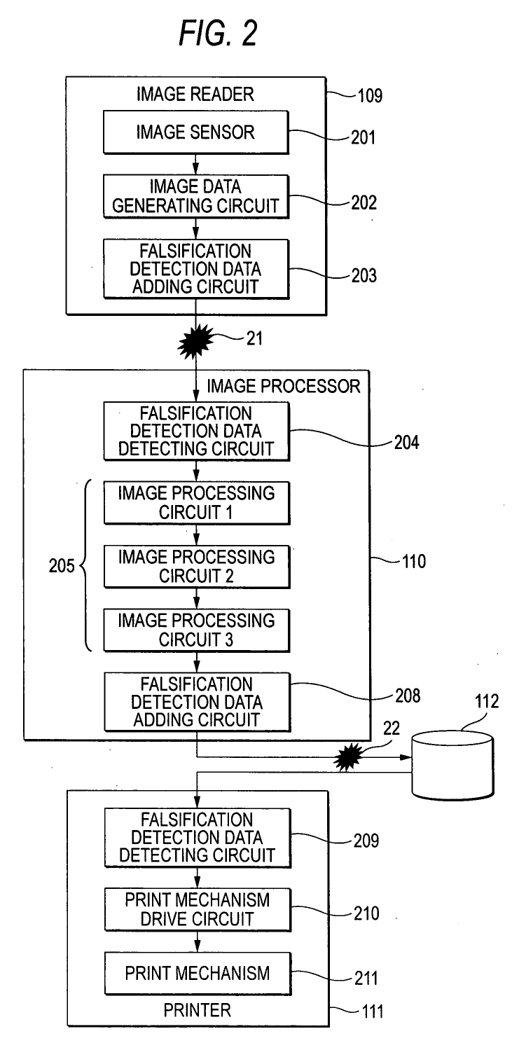

FIG. 2 is a block diagram in which attention is focused on one form of operation of the information processor 101 shown in FIG. 1. FIG. 2 shows a form of operation in which copying is performed by using the information processor 101. FIG. 2 shows an example in which an image on an original is read by the image reader 109, the image data is subjected to image processing by the image processor 110, and the image data after the image processing is temporarily stored in the hard disk drive 112 and is subsequently sent to the printer 111 to perform printing.

As shown in FIG. 2, the image reader 109 in this exemplary embodiment includes an image sensor 201, an image data generating circuit 202, and a falsification detection data adding circuit 203. The image sensor 201 optically reads an image on the original and outputs electrical signals which serve as a basis of the image data. The image data generating circuit 202 converts the output from the image sensor 201 into predetermined data standards to generate image data. The falsification detection data adding circuit 203 adds addition data for detecting the presence or absence of falsification (hereafter, falsification detection data) to the image data outputted from the image data generating circuit 202. In this example, each time a predetermined amount of data is sent, the falsification detection data set in advance is added to the end of a data stream. As the predetermined amount of data to which the falsification detection data is added, it is possible to cite a line unit, a page unit, or a predetermined amount of data suitable for processing in that apparatus.

It should be noted that the falsification refers to an act of accessing the image reader (or an information processing system) and rewriting the information being handled in the image reader without obtaining permission from its administrator. This rewriting includes the deletion of at least a part of the contents, addition of the contents, and modification of at least a part of it.

As shown in FIG. 2, the image processor 110 includes a falsification detection data detecting circuit 204, image processing circuits 1 to 3 (205), and a falsification detection data adding circuit 208. The image processing circuits 1 to 3 (205) are configured by application specific integrated circuits (ASICs) or field programmable gate arrays (FPGAS). Here, although three units are described as the image processing circuits as one example, an arbitrary number of units are disposed in correspondence with the image processing required. As examples of image processing, it is possible to cite conversion processing into a predetermined data format, color space conversion processing for determining coloration, resolution conversion processing for determining a resolution, filtering processing for performing noise removal, contour correction, and the like, and screen processing for conversion into a data format which can be interpreted by the printer 111.

The falsification detection data detecting circuit 204 detects the falsification detection data added in the falsification detection data adding circuit 203, and outputs a signal notifying the detection of falsification (falsification detection signal) in a case where the data amount of data streams with the falsification detection data added thereto differs from a preset data amount. It should be noted that the falsification detection data adding circuit 208 has the same function as that of the falsification detection data adding circuit 203.

As shown in FIG. 2, the printer 111 has a falsification detection data detecting circuit 209, a print mechanism drive circuit 210, and a print mechanism 211. The falsification detection data detecting circuit 209 is the same circuit as the falsification detection data detecting circuit 204. The print mechanism 210 includes mechanisms for performing printing, such as a photoconductor drum, a photosensing mechanism, a developing mechanism, a print paper transporting mechanism, and the like. The print mechanism drive circuit 210 is a control circuit for controlling the operation of the print mechanism 211.

### (Operation of the Exemplary Embodiment: Operation of the Information Processor)

Hereafter, a description will be given of an example of the operation of the information processor shown in FIGS. 1 and 2. Here, a description will be given of an example in which copying is performed (the form of operation shown in FIG. 2). Here, a description will be given of an example of the operation in a case where a plurality of copies of one original are outputted.

First, an original to be copied is placed on an unillustrated original table of the image reader 109. An image on the original is then optically read by the image sensor 201, and the image data generating circuit 202 generates image data on the basis of an output from the image sensor 201. The falsification detection data is added to this image data in the falsification detection data adding circuit 203 and is sent to the image processor 110.

The falsification detection data detecting circuit 204 of the image processor 110 detects the falsification detection data added in the received image data. If the predetermined falsification detection data set in advance is not found to have been added for each data amount of a predetermined value set in advance, the falsification detection data detecting circuit 204 outputs a signal for notifying the detection of falsification detection data to the control unit 102. This signal is outputted in any one of the following cases: (1) a case where the falsification detection data is not the predetermined one, (2) a case where although there is no problem in the falsification detection data, the amount of data to which the falsification detection data has been added is not the predetermined value, and (3) a case where the falsification detection data is not the predetermined one, and the amount of data to which the falsification detection data has been added is not the predetermined value

The processing in the image reader 109 and the image processor 110 is carried out by the pipeline method. For example, when the reading of an original is started by the image sensor 201, the image data of that portion of the image for which scan has been completed begins to be generated by the image data generating circuit 202, and is sequentially sent to the falsification detection data adding circuit 203. The falsification detection data adding circuit 203 performs processing for sequentially adding addition data for detecting falsification to the received image data, and sequentially outputs it to the image processor 110. Namely, when processing is considered in a time series, while processing with respect to data on the leading side of the data stream is being carried out by the falsification detection data adding circuit 203, processing with respect to data on the trailing side of the data stream is carried out by the image data generating circuit 202. Thus, in the pipeline method, the respective processings are carried out in parallel so as to reduce the time of pause in the respective processings.

The hard disk drive 112 temporarily stores the image data and outputs it to the printer 111. The data outputted to the printer 111 is sent to the falsification detection data detecting circuit 209 where the detection of the falsification detection data is performed. Subsequently, the image data is sent to the print mechanism drive circuit 210, and the print mechanism drive circuit 210 performs control based on that image data with respect to the print mechanism 211. As a result, a copy on which an image on the original read by the image sensor 201 has been printed is outputted from the print mechanism 211. It should be noted that the processing in the printer 111 is also carried out in the pipeline method.

In this example, since a plurality of same copies are outputted, the image data is temporarily stored in the hard disk drive 112. Then, each time print processing in the printer 111 is carried out, the image data is sent from the hard disk drive 112 to the printer 111 and printing is performed. It should be noted that the image data which is stored in the hard disk drive 112 may be subjected to data compression.

### (Operation of the Exemplary Embodiment: Falsification Detecting Operation 1)

Next, a description will be given of an example of data falsification detecting operation in the example of operation of the above-described information processor 101. Here, a description will be given of an example in which operation control is provided to the printer on the basis of the relationship between the timing of falsification detection and the state of operation of the printer. FIG. 3 is a flowchart illustrating an example of the data falsification detecting operation. When a main power supply is turned on, an operation program for executing the processing shown in FIG. 3 is read from the ROM 105 into the RAM 104, and processing is started (Step S301).

For example, it is assumed that there has been falsification of data in a data transmission path designated at reference numeral 21 in FIG. 2. To cite an example, this falsification of data is effected by unauthorizedly connecting wiring to a data line at the portion designated at reference numeral 21, by leading the data from that portion to a separate board (not shown) installed unauthorizedly, by adding data unauthorizedly there, and by sending falsified data to the image processor 110.

If there has been falsification of data by adding data at the portion of reference numeral 21, the data amount of the data stream where the falsification detection data has been added changes. As a result, a falsification detection signal is outputted from the falsification detection data detecting circuit 204. This falsification detection signal is recognized by the control unit 102 in FIG. 1 to perform detection of the falsification (Step S302). At this time, the control unit 102 determines whether or not the print paper is being transported in the printer 111 (Step S303). Here, the phrase “being transported” refers to the state after the print paper has been drawn out from its storage unit to a transporting system and before printing is started.

If the transport of the print paper is not being effected in the determination in Step S303, an arrangement is provided so that the transport of the print paper from the storage unit of the print paper will not be effected after that to ensure that the print paper will not be outputted from the printer 111 (Step S305). If the transport of the print paper is being effected in the determination in Step S303, the operation proceeds to Step S304 to determine whether or not printing is being performed, i.e., printing on the print paper is being performed. Here, if printing is being performed, the operation proceeds to Step S307, and if not, the operation proceeds to Step S306.

In Step S307, printing is stopped at the point of time when the determination in Step S304 is made or at an appropriate timing after that, and the print paper is outputted without performing subsequent printing. In addition, in Step S306, printing on the print paper is not performed, and the print paper transported through the transporting system is outputted as it is from the printer 111. In this case, if the print paper is a blank sheet of paper, the blank print paper is outputted from the printer. If any one of the processing in Steps S305 to S307 has been carried out, the processing ends (Step S308).

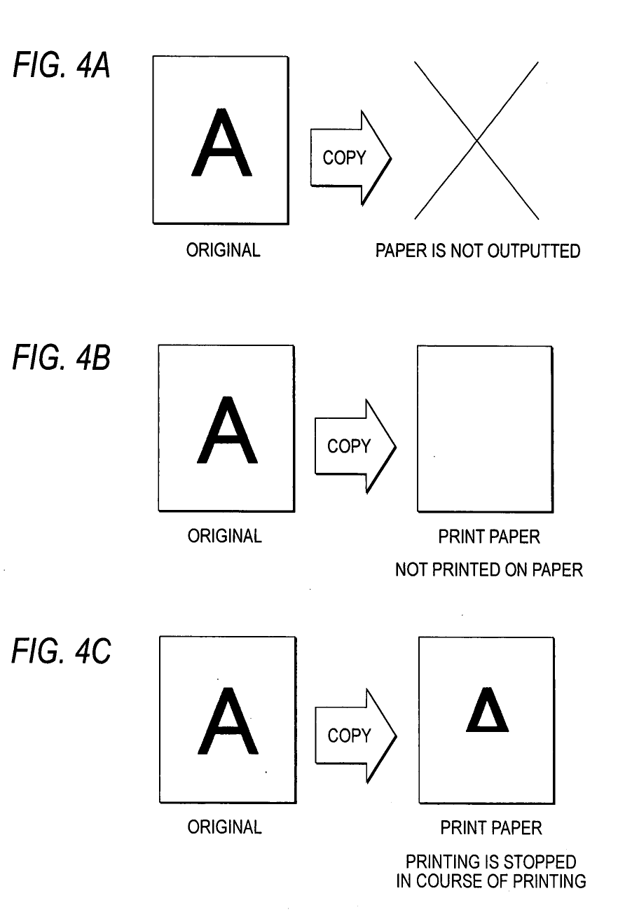

FIGS. 4A to 4C are conceptual diagrams illustrating the states of output of the print paper or states of printing on the print paper, respectively corresponding to Steps S305 to S307. In the case where Step S305 has been executed, the print paper is not outputted, as shown in FIG. 4A. In the case where Step S306 has been executed, the print paper is outputted, as shown in FIG. 4B, but the copied contents of the original (displayed as the alphabet “A” as an example in FIGS. 4A to 4C) is not printed on the print paper, and the print paper is outputted as it is. In the case where Step S307 has been executed, although the printing of the copied contents is effected up to a certain stage, subsequent printing is not performed, and print paper on which printing has been interrupted in mid-course is outputted, as shown in FIG. 4C.

Here, an example has been cited in which falsification of data has been carried out at the portion designated at reference numeral 21. However, according to the processing procedure shown in FIG. 3, it is also possible to detect the falsification of data carried out at the portion designated at reference numeral 22 in FIG. 2. In addition, the program for executing the processing shown in FIG. 3 can be provided by being stored in an appropriate recording medium including a semiconductor memory, an optical disk, a magneto-optical disk, a magnetic storage medium such as a hard disk drive, and the like.

### (Operation of the Exemplary Embodiment: Falsification Detecting Operation 2)

Hereafter, a description will be given of an example in which operation control with respect to the printer is performed on the basis of a detected position of data falsification in the information processor. In this example, in the configuration shown in FIG. 2, all the image data processed by the image processor 110 is temporarily stored in the hard disk drive 112, and that image data is subsequently sent to the printer 111 to perform printing.

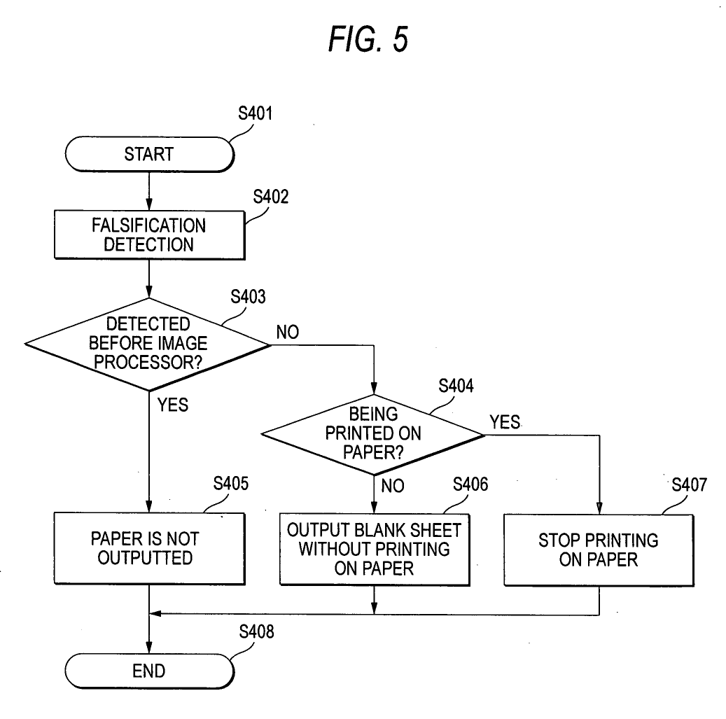

FIG. 5 is a flowchart illustrating an example of the operation of detecting data falsification. In this example, when processing is started (Step S401), and falsification is detected (Step S402), the determination in Step S403 is executed. In Step S403, a determination is made as to whether or not the detected position of the data falsification is a position before the input to the image processor 110 in the flow of the image data.

If the detected position of the data falsification is a position before the image processor 110 (e.g., the position designated at reference numeral 21), it means that the printing operation by the printer 111 has not been started, so that the operation proceeds to Step S405 to ensure that the print paper will not be subsequently transported from the storage unit and the print paper will not be outputted from the printer 111.

If the detected position of the data falsification is not a position before the image processor 110 (e.g., a position designated at reference numeral 22), the operation proceeds to Step S404 in which a determination is made as to whether or not printing on the print paper is underway. If printing is underway, the printing on the paper is stopped (Step S407), and the print paper is outputted without performing subsequent printing, and if printing is not underway, the print paper is outputted without performing printing (Step S406).

### 2. Second Exemplary Embodiment

In Step S307 in FIG. 3, printing may not be stopped, and printing of predetermined contents set in advance or printing of a specific pattern or the like may be performed. In this case, replacement of the print data is carried out. As the predetermined contents for replacement which is printed instead, it is possible to cite the printing of a warning message such as “Printing has been stopped,” “Possibility of data falsification has been detected,” and the like. In addition, it is also possible to print a specific pattern of a gray display, a dot display, or the like. In addition, data in which part of the print data has been thinned out may be printed so that the falsified data will not be printed as it is. As such an example, it is possible to cite, for instance, an example in which print contents has been dropped out in a checkered pattern, and printing is effected to thereby make it difficult to grasp the print contents, or an example in which printing is performed in which the printing of the right half or left half of the print paper is not performed intentionally. By so doing, it is possible to prevent the falsified print contents from being outputted as it is and allow the user to easily recognize the occurrence of falsification of the print data.

### 3. Third Exemplary Embodiment

### (Configuration of the Exemplary Embodiment)

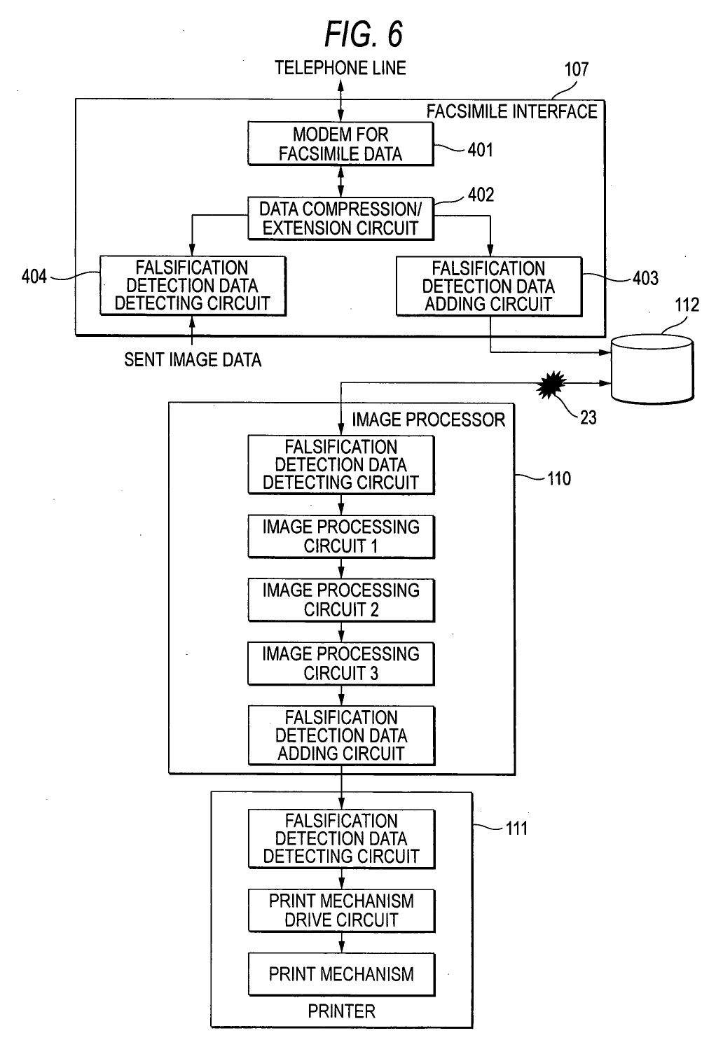

Hereafter, a description will be given of an example of the exemplary embodiment concerning the facsimile function of the information processor 101 shown in FIG. 1. FIG. 6 is a block diagram in which attention is focused on one form of operation of the information processor 101 shown in FIG. 1. FIG. 6 shows an example of the form of operation in which facsimile reception is performed by using the information processor 101. It should be noted that, in this example, although the details of image processing in the image processor 110 are different from those of the case of FIG. 2, necessary functions in the image processor 110 are appropriately selected to perform image processing.

FIG. 6 shows the facsimile interface 107. In this example, the facsimile interface 107 includes a modem 401 for facsimile data, a data compression/extension circuit 402, a falsification detection data adding circuit 403, and a falsification detection data detecting circuit 404. In addition, although the image processor 110 and the printer 111 are shown in FIG. 6, since they are the same as those shown in FIG. 2, a description thereof will be omitted.

The modem 401 for facsimile data is connected to a telephone line, and has the functions of converting facsimile communication data of audio signals transmitted through the telephone line into digital electric signals of image data, and of converting the digital electric signals of image data into audio signals and outputting them to the telephone line. The data compression/extension circuit 402 has the functions of subjecting image data to be transmitted by facsimile to data compression and of extending received image data of facsimile from a data compressed state. The falsification detection data adding circuit 403 has the same function as the falsification detection data adding circuits 203 and 208 shown in FIG. 2. The falsification detection data detecting circuit 404 has the same function as the falsification detection data detecting circuits 204 and 209 shown in FIG. 2.

In the case of this example, the presence or absence of data falsification is monitored between the facsimile interface 107 and the hard disk drive 112. Also, the presence or absence of data falsification is monitored between the hard disk drive 112 and the image processor 110. Still further, the presence or absence of data falsification is monitored between the image processor 110 and the printer 111.

### (Operation of the Exemplary Embodiment)

In FIG. 6, the image data sent to the information processor 101 is converted into digital image data by the modem 401 for facsimile data, and is subjected to extension by the compression/extension circuit 402. Falsification detection data is added to the extended image data in the falsification detection data adding circuit 403, and is sent to the hard disk drive 112. When all the image data is stored in the hard disk drive 112, the image data stored in the hard disk drive 112 is sent to the image processor 110 so as to be subjected to image processing. The image data subjected to image processing is sent to the printer 111 to perform printing. In this operation, the image data outputted from the facsimile interface 107 is temporarily stored in the hard disk drive 112, and is subsequently sent to the image processor 110. The detection of the data falsification is carried out by the processing shown in FIG. 3.

### 4. Fourth Exemplary Embodiment (Configuration of the Exemplary Embodiment)

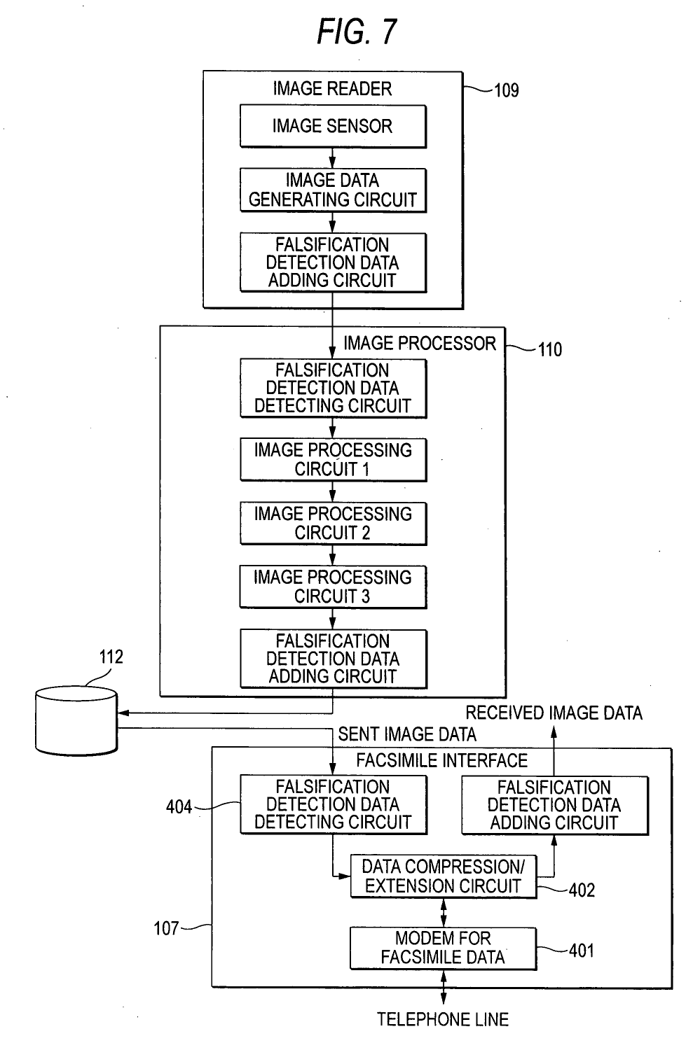

FIG. 7 is a block diagram in which attention is focused on one form of operation of the information processor 101 shown in FIG. 1. FIG. 7 shows an example of the form of operation in which facsimile transmission is performed by using the information processor 101. FIG. 7 shows an example in which an image on the original is read by the image reader 109, image processing is executed on image data by the image processor 110, and the image data after being temporarily stored in the hard disk drive 112 is sent to the facsimile interface 107 and is transmitted as a facsimile image. It should be noted that, in this example, although the details of image processing in the image processor 110 are different from those of the cases of FIGS. 2 and 6, necessary functions in the image processor 110 are appropriately selected to perform image processing.

In the case of this example, the presence or absence of data falsification is monitored between the image reader 109 and the image processor 110. Also, the presence or absence of data falsification is monitored between the image processor 110 and the hard disk drive 112 and between the hard disk drive 112 and the facsimile interface 107.

### (Operation of the Exemplary Embodiment)

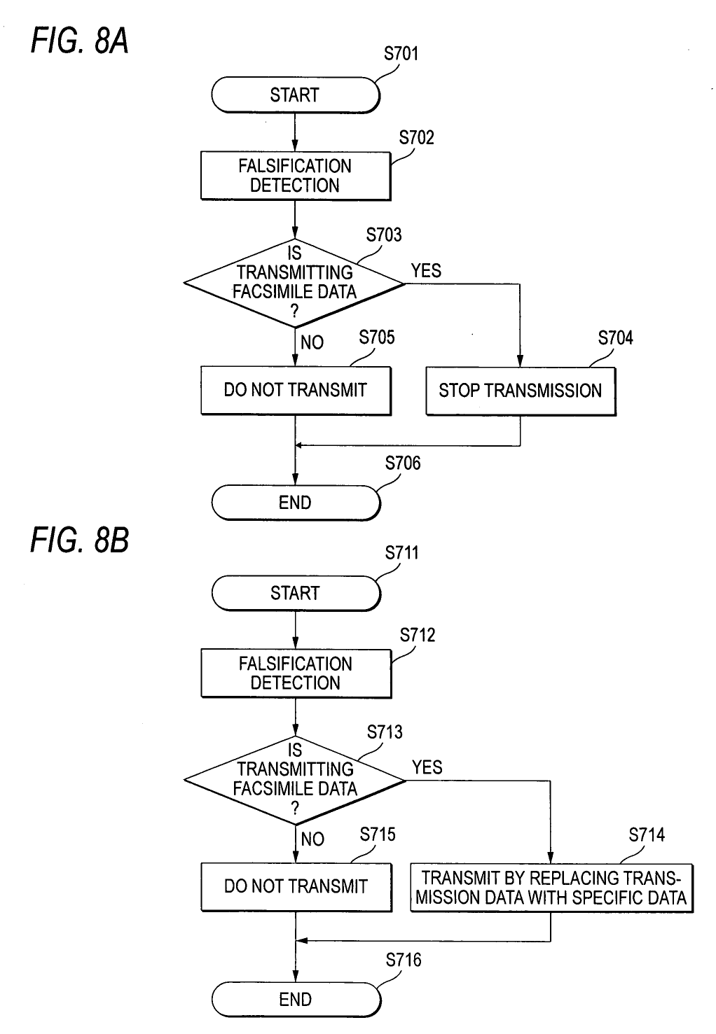

FIGS. 8A and 8B are flowcharts illustrating examples of the data falsification detecting operation. FIG. 8A shows a first example, and FIG. 8B shows a second example. Hereafter, a description will be given of an example of the operation in the configuration shown in FIG. 7. In the processing shown in FIG. 8A, when processing is started (Step S701), and falsification is detected (Step S702), a determination is made as to whether or not the modem 401 for facsimile data (see FIG. 7) is transmitting facsimile data to the telephone line (Step S703). If the modem 401 for facsimile data is transmitting facsimile data, subsequent transmission is stopped (Step S704). In this case, the transmission of the facsimile data is interrupted in mid-course. On the other hand, if the modem 401 for facsimile data is not transmitting facsimile data, it is ensured that subsequent transmission will not be effected (Step S705). After executing Step S704 or Step S705, the processing ends (Step S706).

In the processing shown in FIG. 8B, when processing is started (Step S711), and falsification is detected (Step S712), a determination is made as to whether or not the modem 401 for facsimile data is transmitting facsimile data to the telephone line (Step S713). If the modem 401 for facsimile data is transmitting facsimile data, the transmission is carried out by replacing the data with data having contents which do not present a problem even if it comes to a third party's notice, or with data having contents informing the other party that there has been trouble (Step S714). On the other hand, if the modem 401 for facsimile data is not transmitting facsimile data, it is ensured that subsequent transmission will not be effected (Step S715). After executing Step S714 or Step S715, the processing ends (Step S716).

### 5. Fifth Exemplary Embodiment

As a modification of the fourth exemplary embodiment, it is possible to cite an example of the configuration making use of the communication interface 108 (see FIG. 1) instead of the facsimile interface 107. In this case, data is outputted to a communication line such as the Internet by making use of the communication interface instead of facsimile communication. In this case, the data to be transmitted is not limited to image data, and may be, for example, music data or the like.

### 6. Sixth Exemplary Embodiment

FIGS. 2, 6, and 7 show examples in which the detection of data falsification is performed by using the falsification detection data detecting circuit, it is also possible to detect the falsification detection data in the CPU 103 (see FIG. 1) and determine the presence or absence of the data falsification.

### 7. Seventh Exemplary Embodiment

### (Configuration of the Exemplary Embodiment)

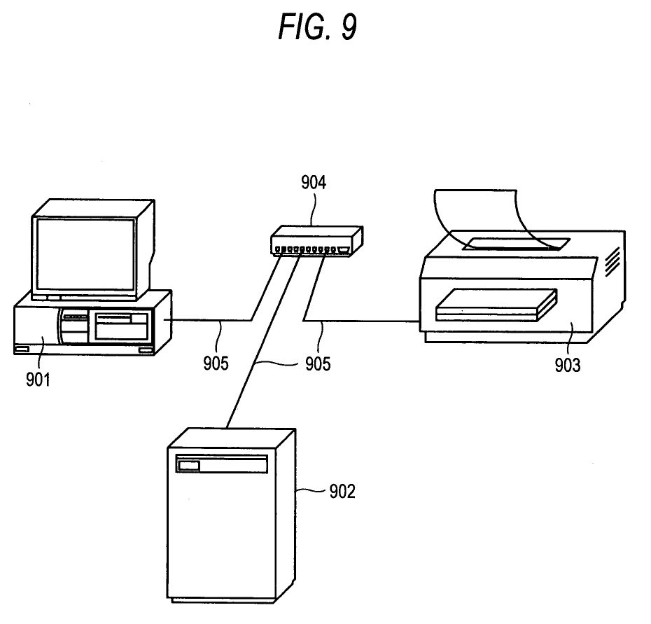

The present invention can be used in an information processing system in which a personal computer, a server, a printer, and the like are connected by a LAN or the like. FIG. 9 is a conceptual diagram illustrating an example of the information processing system which makes use of the invention. FIG. 9 shows a configuration in which a personal computer 901, a server 902, and an information processor 903 having a printing function are connected to a hub 904 by signal lines 905 of an appropriate communication standard.

Each of the personal computer 901, the server 902, and the information processor 903 having the printing function has the falsification detection data adding circuit and the falsification detection data detecting circuit. The falsification detection data adding circuit and the falsification detection data detecting circuit are mounted on an extension board for realizing a predetermined communication interface function, and each of the apparatuses has the falsification detection data adding circuit and the falsification detection data detecting circuit as this extension board is mounted thereon. In addition, information on addition conditions and contents of the falsification detection data are shared in advance in the respective apparatuses. For this reason, it is possible to detect the presence or absence of data falsification midway in the transmission path of data exchanged within the system.

Here, the information processor 903 having the printing function has a configuration shown in FIG. 1, for example, and in a case where the falsification of data has been detected, the information processor 903 is able to control the printing operation, as shown in FIG. 3, for example. In addition, the server 902 has the function of a computer, and has a function whereby when falsification on the transmission path of the data received is detected, the transmission of that data to the outside is disabled (i.e., a setting is provided such that the data is made unreadable from the outside).

### (Operation 1 of the Exemplary Embodiment)

A description will be given of an example in which, for instance, print data is sent from the personal computer 901 to the information processor 903 having the printing function, and printing is perform. In this case, the falsification detection data is added to the print data which is sent from the personal computer 901 via the hub 904 to the information processor 903 having the printing function. The information processor 903 having the printing function executes the processing shown in FIG. 3, for example, and in a case where the falsification of data on the transmission path has been detected, the information processor 903 controls the printing operation on the basis of the detection timing. Specifically, control is provided in which if the transport of the print paper is not being effected, printing is not performed. On the other hand, in a situation in which although the transport of the print paper is being effected, printing has not been performed, the print paper is outputted as it is without performing printing. Further, in a situation in which printing has been performed, the printing is stopped at a certain stage, and the print paper is outputted.

### (Operation 2 of the Exemplary Embodiment)

A description will be given of a case where, for instance, the personal computer 901 is operated to read out data from the server 902, and its contents is printed from the information processor 903. In this case, in a case where falsification of data on the data transmission path from the server 902 to the personal computer 901 has been detected, control is provided in the personal computer 901 whereby the transmission of data from the personal computer 901 to the information processor 903 having the printing function is disabled. In addition, in a case where falsification of data on the data transmission path from the personal computer 901 to the information processor 903 having the printing function has been detected, processing similar to that of the “Operation 1 of the Exemplary Embodiment” described above is executed.

### 8. Eighth Exemplary Embodiment

In the first to seventh exemplary embodiments, a hash value may be used as the falsification detection data. In this case, for example, in the falsification detection data adding circuit 203 shown in FIG. 2, an appropriate hash function is used, and a hash value is calculated on the basis of data of a predetermined data amount and is added to the relevant data stream as the falsification detection data. The falsification detection data detecting circuit 204 performs processing similar to the one described above on the basis of the received data to calculate a hash value of that data. At this time, a falsification detection signal is outputted from the falsification detection data detecting circuit 204 if the calculated hash value does not agree with the hash value received by the falsification detection data detecting circuit 204. Similar processing is also executed in the falsification detection data adding circuit 208 and the falsification detection data detecting circuit 209.

The present invention can be utilized in an image information output apparatus and an image information output system.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image information output apparatus comprising:
an image processing section that performs image processing on image information;
an image information output section that outputs the image information subjected to image processing by the image processing section;
a falsification detecting section that detects that the image information has been falsified in a process in which the inputted image information is subjected to image processing by the image processing section and is outputted by the image information output section; and
a control section that controls an output of the image information by the image information output section based on a detection result detected by the falsification detecting section.

2. The image information output apparatus according to claim 1,
wherein the control section controls the output of the image information based on a relationship between a state of operation of the image information output section and a timing of detection by the falsification detecting section.

3. The image information output apparatus according to claim 1,
wherein the control section controls the output of the image information based on a location where the falsification detection has been performed by the falsification detecting section.

4. The image information output apparatus according to claim 1,
wherein the image output section is a printing section that prints the image information on a paper, and
the control section provides control to stop printing of an image on the paper by the printing section with respect to the image information whose falsification has been detected by the falsification detecting section, or provides control to allow the printing section to print a predetermined content set in advance.

5. The image information output apparatus according to claim 4,
wherein the control section provides control such that in a case where falsification detection has been performed by the falsification detecting section, transport of the paper is stopped, and printing of image on the paper by the printing section is stopped based on the image information whose falsification has been detected by the falsification detecting section.

6. The image information output apparatus according to claim 4,
wherein the control section provides control such that in a case where falsification detection has been performed by the falsification detecting section, transport of the paper is continued, and printing on the paper is not performed on at least part of the image information whose falsification has been detected by the falsification detecting section.

7. The image information output apparatus according to claim 1,
wherein the image output section is a facsimile transmitting section, and
the control section provides control to stop the transmission by the facsimile transmitting section with respect to the image information whose falsification has been detected by the falsification detecting section, or provides control to allow the facsimile transmitting section to transmit a predetermined content set in advance.

8. An image information output method comprising:
image processing on image information;
outputting the image information subjected to the image processing,
detecting falsification of the image information in a process in which the image processing is performed and its output is made; and
controlling the outputting of the image information based on a result of the detecting.

9. The image information output method according to claim 8,
wherein the controlling of the outputting is provided based on a relationship between a state of output of the image information and a timing of the detection.

10. The image information output method according to claim 8,
wherein the controlling of the outputting is provided based on a location where the falsification detection has been performed.

11. The image information output method according to claim 8,
wherein the outputting is printing, and
the controlling of the outputting is controlling for stopping printing on paper with respect to the image information whose falsification has been detected or controlling for printing a predetermined content set in advance.

12. The image information output method according to claim 11,
wherein, the controlling of the outputting is provided such that in a case where the falsification has been detected, the transport of the paper is stopped, and the printing is stopped based on the image information whose falsification has been detected.

13. The image information output method according to claim 11,
wherein the controlling of the outputting is provided such that in a case where the falsification has been detected, the transport of the paper is continued, and printing on the paper is not performed on at least part of the image information whose falsification has been detected.

14. The image information output method according to claim 8,
wherein the outputting is transmission of a facsimile image, and,
in the controlling of the outputting, control for stopping the transmission of the facsimile image or control for effecting the transmission of a facsimile image having a predetermined content set in advance is provided.

15. A computer readable medium storing a program causing a computer to execute a process for image information output, the process comprising:
image processing on image information;
outputting the image information subjected to the image processing,
detecting falsification of the image information in a process in which the image processing is performed and its output is made; and
controlling the outputting of the image information based on a result of the detecting.

16. The computer readable medium according to claim 15,
wherein the controlling of the outputting is provided based on a relationship between a state of output of the image information and a timing of the detection.

17. The computer readable medium according to claim 15,
wherein the controlling of the outputting is provided based on a location where the falsification detection has been performed.

18. The computer readable medium according to claim 15,
wherein the outputting is printing, and
the controlling of the outputting is controlling for stopping printing on paper with respect to the image information whose falsification has been detected or controlling for printing a predetermined content set in advance.

19. The computer readable medium according to claim 18,
wherein, the controlling of the outputting is provided such that in a case where the falsification has been detected, the transport of the paper is stopped, and the printing is stopped based on the image information whose falsification has been detected.

20. The computer readable medium according to claim 18,
wherein the controlling of the outputting is provided such that in a case where the falsification has been detected, the transport of the paper is continued, and printing on the paper is not performed on at least part of the image information whose falsification has been detected.

21. The computer readable medium according to claim 15,
wherein the outputting is transmission of a facsimile image, and,
in the controlling of the outputting, control for stopping the transmission of the facsimile image or control for effecting the transmission of a facsimile image having a predetermined content set in advance is provided.

22. A computer data signal embodied in a carrier wave for enabling a computer to perform a process for image information output, the process comprising:
image processing on image information;
outputting the image information subjected to the image processing,
detecting falsification of the image information in a process in which the image processing is performed and its output is made; and
controlling the outputting of the image information based on a result of the detecting.

23. The computer data signal according to claim 22,
wherein the controlling of the outputting is provided based on a relationship between a state of output of the image information and a timing of the detection.

24. The computer data signal according to claim 22,
wherein the controlling of the outputting is provided based on a location where the falsification detection has been performed.

25. The computer data signal according to claim 22,
wherein the outputting is printing, and
the controlling of the outputting is controlling for stopping printing on paper with respect to the image information whose falsification has been detected or controlling for printing a predetermined content set in advance.

26. The computer data signal according to claim 25,
wherein, the controlling of the outputting is provided such that in a case where the falsification has been detected, the transport of the paper is stopped, and the printing is stopped based on the image information whose falsification has been detected.

27. The computer data signal according to claim 25,
wherein the controlling of the outputting is provided such that in a case where the falsification has been detected, the transport of the paper is continued, and printing on the paper is not performed on at least part of the image information whose falsification has been detected.

28. The computer data signal according to claim 22,
wherein the outputting is transmission of a facsimile image, and,
in the controlling of the outputting, control for stopping the transmission of the facsimile image or control for effecting the transmission of a facsimile image having a predetermined content set in advance is provided.
